(19) United States
(12) Patent Application Publication
(10) Pub. No.: US 2024/0097164 A1
(43) Pub. Date: Mar. 21, 2024

(54) FUEL CELL SYSTEM

(71) Applicant: HONDA MOTOR CO., LTD., Tokyo (JP)

(72) Inventors: Tomoyuki INOUE, WAKO-SHI (JP); Yuto NAKATANI, WAKO-SHI (JP)

(21) Appl. No.: 18/244,956

(22) Filed: Sep. 12, 2023

(30) Foreign Application Priority Data
Sep. 15, 2022 (JP) 2022-146658

(51) Int. Cl. H01M 8/04746; H01M 8/04082; H01M 8/04302; H01M 8/0438; H01M 8/04537; H01M 8/04664

(52) U.S. Cl. CPC H01M 8/04753; H01M 8/04201; H01M 8/04302; H01M 8/04388; H01M 8/04395; H01M 8/04619; H01M 8/04679; H01M 8/04761

(57) ABSTRACT

A controller allows an injector to inject a fuel gas when a supply flow rate of an oxygen-containing gas reaches a set flow rate for the oxygen-containing gas supplied at start-up in a state where a supply-side stop valve and a discharge-side stop valve are closed, and thereafter opens the supply-side stop valve and the discharge-side stop valve.

### CROSS-REFERENCE TO RELATED APPLICATIONS

This application is based upon and claims the benefit of priority from Japanese Patent Application No. 2022-146658 filed on Sep. 15, 2022, the contents of which are incorporated herein by reference.

### BACKGROUND OF THE INVENTION

### Field of the Invention

The present invention relates to a fuel cell system for generating electricity by electrochemical reactions of a fuel gas and an oxygen-containing gas.

### Description of the Related Art

In recent years, research and development have been conducted on fuel cells (FCs) that contribute to energy efficiency in order to ensure that more people have access to affordable, reliable, sustainable and modern energy.

For example, JP 2004-172027 A discloses a fuel cell system that prevents a high-concentration fuel gas, which has remained on the anode side when the fuel cell system is stopped and then diffused (permeated) to the cathode side through an electrolyte membrane, from being released to the atmosphere from an exhaust pipe on the cathode side at the time when the oxygen-containing gas is supplied to the cathode side in starting up the fuel cell system.

In the fuel cell system disclosed in JP 2004-172027 A, a supply pipe used for supplying the oxygen-containing gas from an air pump to the cathode side is provided with a bypass channel communicating with the exhaust pipe and having an openable/closable bypass valve.

In the fuel cell system disclosed in JP 2004-172027 A, it is determined whether or not the hydrogen concentration on the cathode side is equal to or higher than a predetermined value at the time of start-up. In the case of the hydrogen concentration being equal to or higher than the predetermined value, the operation of the air pump is restricted to reduce the flow rate of the oxygen-containing gas supplied, and the oxygen-containing gas is supplied to the exhaust pipe through the bypass channel to reduce the concentration of the fuel gas discharged to the atmosphere.

### SUMMARY OF THE INVENTION

However, if the operation of the air pump is restricted at the time of start-up, there is a problem that the activation time until the air pump is brought into the normal operational state becomes longer, and thus the activation time of the fuel cell stack becomes longer.

Further, in the fuel cell system disclosed in JP 2004-172027 A, even when the anode-side discharge valve is unintentionally opened due to a failure or the like, the operation of the air pump is restricted at the time of start-up. In this case, the same problem that the activation time until the air pump is brought into the normal operation state becomes longer, and thus the activation time of the fuel cell stack becomes longer occurs.

An object of the present invention is to solve the aforementioned problem.

According to an aspect of the present invention, there is provided a fuel cell system including: a fuel cell stack configured to generate electricity by electrochemical reactions between a fuel gas supplied to an anode through an anode flow field and an oxygen-containing gas supplied to a cathode through a cathode flow field; an oxygen-containing gas supply device configured to supply the oxygen-containing gas to the cathode flow field in the fuel cell stack through an oxygen-containing gas supply flow path, an oxygen-containing off-gas discharge flow path through which the oxygen-containing off-gas having been subjected to the electrochemical reactions flows from the fuel cell stack, a bypass channel connecting the oxygen-containing gas supply flow path and the oxygen-containing off-gas discharge flow path and configured to allow the oxygen-containing gas supplied from the oxygen-containing gas supply device to flow into the oxygen-containing off-gas discharge flow path while bypassing the cathode flow field in the fuel cell stack; and one or more processors that execute computer-executable instructions stored in a memory, wherein the one or more processors execute the computer-executable instructions to cause the fuel cell system to detect fuel gas leakage while the fuel cell system is in operation and after an operation of the fuel cell system has been ended, and set, based on a detection result, a flow rate of the oxygen-containing gas supplied at start-up in the case of no fuel gas leakage detected to be lower than a flow rate supplied at start-up after the fuel gas leakage is detected.

According to the present invention, it is possible to reduce the flow rate of the oxygen-containing gas supplied at start-up of the fuel cell system because the flow rate of the oxygen-containing gas supplied at start-up is set on the basis of the detection results of fuel gas leakage during and after the most recent operation of the fuel cell system. As a result, the activation time until power generation is started can be shortened.

In the case where fuel gas leakage has been detected by the start-up, the flow rate of the oxygen-containing gas to be supplied is set to be larger than that set in the case where no leakage has been detected, so as to shorten the time taken by dilution for lowering the concentration of the fuel gas to be discharged to the atmosphere, and consequently shorten the activation time.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic configuration diagram of a fuel cell vehicle, into which a fuel cell system according to the present embodiment is incorporated;

FIG. 2 is a flowchart illustrating an operational procedure of an activation control processing of the fuel cell system by the controller; and

FIG. 3 is a timing chart showing an example of the operations illustrated by the flowchart of FIG. 2.

### DETAILED DESCRIPTION OF THE INVENTION

### Configuration

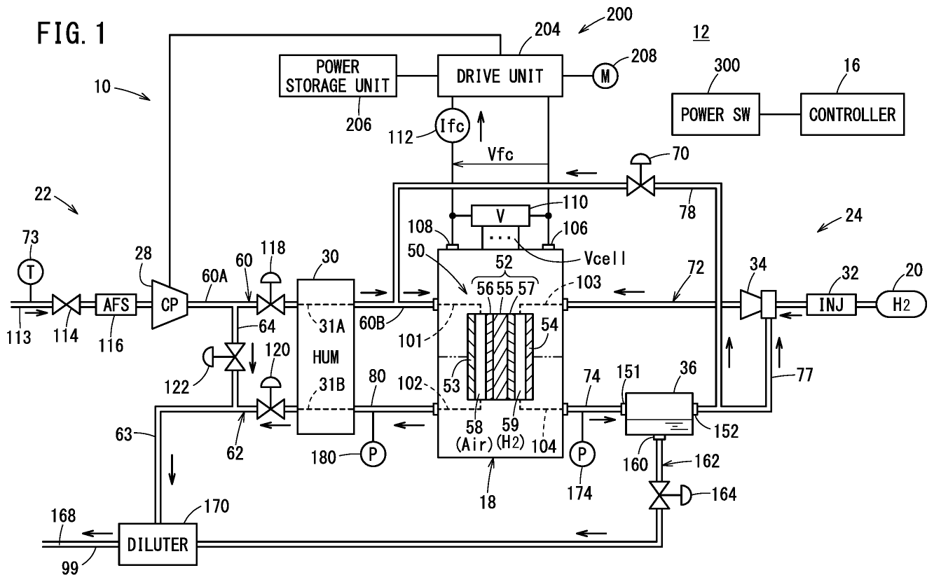

FIG. 1 is a schematic configuration diagram of a fuel cell vehicle 12, into which a fuel cell system 10 according to an embodiment of the present invention is incorporated; the fuel cell system 10 can be incorporated into any mobile objects such as automobiles, ships, aircrafts, and robots, other than the fuel cell vehicle 12.

The fuel cell vehicle 12 includes a controller 16 for controlling the entire fuel cell vehicle 12, the fuel cell system 10, and an output unit 200 electrically connected to the fuel cell system 10.

Two or more controllers 16 may be provided, for example, one for the fuel cell system 10, one for the output unit 200, and so on.

The fuel cell system 10 includes a fuel cell stack 18, a hydrogen tank (fuel gas tank) 20, an oxygen-containing gas supply device 22, and a fuel gas supply device 24.

The output unit 200 includes a drive unit 204, a power storage unit 206, and a motor 208. The drive unit 204 includes a boosting converter, a plurality of inverters, and the like, which are not illustrated.

The power storage unit 206 includes a power storage device (high-voltage battery) that stores high-voltage electrical energy, a step-down converter that converts the high voltage to a low voltage, and a power storage device (low-voltage battery) that stores the low-voltage electrical energy.

A negative terminal 106 and a positive terminal 108 of the fuel cell stack 18 are connected to input terminals of the drive unit 204 through electric cables, respectively. A voltage sensor 110 is provided between the negative terminal 106 and the positive terminal 108.

The voltage sensor 110 measures (detects) a fuel cell voltage (generated electrical voltage) Vfc which is a voltage between the negative terminal 106 and the positive terminal 108.

The voltage sensor 110 also measures (detects) a voltage (cell voltage) Vcell of each power generation cell 50 constituting the fuel cell stack 18.

A current sensor 112 that measures (detects) a generated current Ifc of the fuel cell stack 18 is inserted into one or both of the electric cables.

The boosting converter of the drive unit 204 boosts the generated electrical voltage Vfc which is a DC voltage. The inverter converts the boosted DC voltage into a three phase AC voltage and supplies the three phase AC voltage to the motor 208. The electrical energy (generated energy) having the boosted DC voltage is stored in the high-voltage battery of the power storage unit 206.

The motor 208 is operated by the high-voltage electric power stored in the high-voltage battery of the power storage unit 206 or the high-voltage electric power obtained by boosting the electrical voltage Vfc generated by the fuel cell stack 18.

The electrical energy generated by regenerative power of the motor 208 is charged into the high-voltage battery through the inverter.

The drive unit 204 is further connected to a compressor 28 by an electric cable and rotationally drives the compressor 28 through the inverter. The rotational speed N [rpm] of the rotor of the compressor 28 is detected by the controller 16 via a resolver (not shown) or the like.

The fuel cell stack 18 generates electric power through electrochemical reactions between a fuel gas and an oxygen-containing gas. Examples of the fuel gas include hydrogen gas. Examples of the oxygen-containing gas include air containing oxygen gas.

In the fuel cell stack 18, a plurality of power generation cells 50 are stacked. Each of the power generation cells 50 includes a membrane electrode assembly 52, and a pair of separators 53, 54 that sandwich the membrane electrode assembly 52.

Each of the membrane electrode assemblies 52, for example, is equipped with a solid polymer electrolyte membrane 55 in which a thin film of perfluorosulfonic acid is impregnated with water, and a cathode 56 and an anode 57 sandwiching the solid polymer electrolyte membrane 55.

Each of the cathode 56 and the anode 57 has a gas diffusion layer (not shown) made from carbon paper or the like. An electrode catalyst layer (not shown) of a platinum alloy supported on porous carbon particles is coated uniformly on the surface of the gas diffusion layer. The electrode catalyst layer is formed on both surfaces of the solid polymer electrolyte membrane 55, respectively.

On the side of the one separator 53 that faces the membrane electrode assembly 52, a cathode side flow field 58 in communication with an oxygen-containing gas supply passage 101 and an oxygen-containing gas discharge passage 102 is formed.

On the side of the other separator 54 that faces the membrane electrode assembly 52, an anode side flow field 59 in communication with a fuel gas supply passage 103 and a fuel gas discharge passage 104 is formed.

In the anode 57, by the fuel gas (hydrogen) being supplied, hydrogen ions are generated from hydrogen molecules by electrode reactions caused by catalyst, and the hydrogen ions pass through the solid polymer electrolyte membrane 55 and then move to the cathode 56, while electrons are released from hydrogen molecules. Electrons released from hydrogen molecules move from the negative terminal 106 to the positive terminal 108 through the loads such as the drive unit 204, and then to the cathode 56.

At the cathode 56, by action of the catalyst, the hydrogen ions and the electrons, and oxygen contained in the supplied oxygen-containing gas are reacted to produce water. The oxygen-containing gas supply device 22 supplies the oxygen-containing gas to the fuel cell stack 18. The oxygen-containing gas supply device 22 includes the compressor (CP) 28 and a humidifier (HUM) 30.

The compressor 28 is an electric air compressor employing an air bearing for floating the rotor from a bearing by compressed air, and has functions such as sucking and pressurizing outside air (atmosphere, air) from an outside air intake port 113, and supplying it to the fuel cell stack 18 through the humidifier 30, and the like. The outside air intake hole 113 is provided with a temperature sensor 73 that measures (detects) an outside air temperature Ta.

The humidifier 30 has a flow path 31A and a flow path 31B. Air (oxygen-containing gas) compressed, heated to a high temperature and dried by the compressor 28 flows through the flow path 31A. The exhaust gas (oxygen-containing off-gas) discharged from the oxygen-containing gas discharge passage 102 of the fuel cell stack 18 flows through the flow path 31B.

A pressure sensor 180 that measures (detects) a gas pressure Pk at the oxygen-containing gas outlet is provided in an oxygen-containing off-gas discharge flow path 80 between the oxygen-containing gas discharge passage 102 and the humidifier 30.

Here, the exhaust gas discharged from the fuel cell stack 18 to the oxygen-containing off-gas discharge flow path 80 while the fuel cell system 10 is in operation (in power generation) is a wet oxygen-containing off-gas (wet cathode off-gas, wet oxygen-containing exhaust gas) as long as a bleed valve 70 is closed, and is a wet exhaust gas (off-gas) as a mixture of the wet oxygen-containing off-gas and a fuel off-gas (anode off-gas, fuel exhaust gas) as long as the bleed valve 70 is opened.

The humidifier 30 has a function of humidifying the oxygen-containing gas supplied from the compressor 28. That is, the humidifier 30 transfers moisture contained in the exhaust gas (off-gas) flowing through the flow path 31B to a supply gas (oxygen-containing gas) flowing through the flow path 31A via an internally provided porous membrane to supply a humidified oxygen-containing gas to the fuel cell stack 18.

A shut-off valve 114, an air flow sensor (AFS: flow rate sensor) 116, the compressor 28, a supply-side stop valve 118, and the humidifier 30 are provided on the oxygen-containing gas supply flow path 60 (including oxygen-containing gas supply flow paths 60A, 60B) extending from the outside air intake hole 113 to the oxygen-containing gas supply passage 101 in order from the outside air intake hole 113. The flow paths such as the oxygen-containing gas supply flow path 60 drawn by double lines are formed by pipes (the same applies to the following description). The shut-off valve 114 is opened to allow and close to shut off intake of the air into the oxygen-containing gas supply flow path 60.

The air flow sensor 116 measures (detects) the flow rate (mass flow rate [g/s]) of the oxygen-containing gas supplied to the fuel cell stack 18 through the compressor 28. The mass flow rate can be uniquely converted into a volume flow rate [m³/s] by dividing the mass flow rate by a density [g/m³] of the air calculated using the equation of state based on the air temperature (outside air temperature Ta) and the air pressure. The local atmospheric pressure can be obtained by accessing a database of the Meteorological Agency, for example. The supply-side stop valve 118 opens and closes the oxygen-containing gas supply flow path 60A.

The humidifier 30 and a discharge-side stop valve 120 that also functions as a back pressure valve are disposed on the oxygen-containing off-gas discharge flow path 62 in communication with the oxygen-containing gas discharge passage 102 in this order from the oxygen-containing gas discharge passage 102.

A bypass channel 64 is provided between a suction inlet of the supply-side stop valve 118 and a discharge outlet of the discharge-side stop valve 120 to allow the oxygen-containing gas supply flow path 60 and the oxygen-containing off-gas discharge flow path 62 to communicate with each other. The bypass channel 64 is connected between the oxygen-containing gas supply flow path 60 and the oxygen-containing off-gas discharge flow path 62 in order to allow the oxygen-containing gas to bypass the fuel cell stack 18. The bypass channel 64 is provided with a bypass valve 122 that opens and closes the bypass channel 64. The bypass valve 122 adjusts the flow rate of the oxygen-containing gas bypassing the fuel cell stack 18. The bypass channel 64 and the oxygen-containing off-gas discharge flow path 62 communicate with a dilution gas flow path 63.

A hydrogen tank 20 is a container including a solenoid shut-off valve (not shown), and stores highly pure hydrogen compressed under high pressure.

The fuel gas supply device 24 supplies the fuel gas from the hydrogen tank 20 to the fuel cell stack 18. The fuel gas supply device 24 includes an injector (INJ) 32, an ejector 34, and a gas-liquid separator (GLS) 36. The injector 32 may be replaced with a pressure reducing valve.

The fuel gas discharged from the hydrogen tank 20 flows through the injector 32 and the ejector 34 that are disposed on a fuel gas supply flow path 72, and is then supplied to an inlet of the anode flow field 59 of the fuel cell stack 18 through the fuel gas supply passage 103.

An outlet of the anode flow field 59 is connected to an inlet 151 of the gas liquid separator 36 through the fuel gas discharge passage 104 and a fuel off-gas discharge flow path 74, and a fuel off-gas as a hydrogen-containing gas is discharged to the gas liquid separator 36 from the anode flow field 59.

A pressure sensor 174 that measures (detects) a gas pressure Pa (of the fuel off-gas) at the fuel gas outlet is provided in the fuel off-gas discharge flow path 74 between the fuel gas discharge passage 104 and the gas-liquid separator 36.

The gas liquid separator 36 separates the fuel off-gas into gaseous components and liquid components (water). The gaseous components of the fuel off-gas (fuel exhaust gas) are discharged from a gas discharge hole 152 of the gas-liquid separator 36 and supplied to the suction inlet of the ejector 34 through a circulating flow path 77. On the other hand, while the bleed valve 70 is opened, the fuel off-gas is also supplied to the oxygen-containing gas supply flow path 60B through a connecting flow path (communication flow path) 78 and the bleed valve 70.

The liquid components of the fuel exhaust gas are supplied from a liquid discharge hole 160 of the gas-liquid separator 36 through a drain channel 162 to a diluter 170 disposed at the merge point with the dilution gas flow path 63 communicating with the oxygen-containing off-gas discharge flow path 62.

An exhaust passage 99 is connected to the diluter 170. The oxygen-containing exhaust gas discharged through the oxygen-containing off-gas discharge flow path 62 and the fuel exhaust gas discharged through the drain channel 162 are mixed in the exhaust passage 99 and discharged to the outside through an exhaust gas opening 168.

In practice, a part of the fuel off-gas (hydrogen-containing gas) is discharged to the drain channel 162 together with the liquid components. In order to dilute the hydrogen gas in the fuel off-gas before discharging it to the outside, a part of the oxygen-containing gas discharged from the compressor 28 is supplied to the diluter 170 through the bypass channel 64.

The bleed valve 70 is disposed on the connecting flow path 78 in communication with the circulating flow path 77 of the fuel off-gas and the oxygen-containing gas supply flow path 60B.

The bleed valve 70 is opened to prevent deterioration of the anode 57 caused by a decrease in the hydrogen concentration in the anode flow field 59 due to permeation of the nitrogen gas from the cathode flow field 58 through the membrane electrode assembly 52 while the moving object, on which the fuel cell system 10 is mounted, is moving.

When the bleed valve 70 is opened, the fuel off-gas discharged from the fuel cell stack 18 through the fuel off-gas discharge flow path 74 via the gas-liquid separator 36 flows to the cathode flow field 58 through the connecting flow path 78, the oxygen-containing gas supply flow path 60B and the oxygen-containing gas supply passage 101.

The fuel gas in the fuel off-gas flowing through the cathode flow field 58 is ionized into hydrogen ions by catalytic reactions at the cathode 56, and the hydrogen ions react with the oxygen-containing gas to produce water. The remaining unreacted fuel off-gas (composed of nitrogen gas and a small amount of unreacted hydrogen gas) is discharged from the oxygen-containing gas discharge passage 102 of the fuel cell stack 18 as the oxygen-containing off-gas, and flows through the oxygen-containing off-gas discharge flow path 62.

The oxygen-containing off-gas (including the unreacted remaining fuel off-gas) flowing through the oxygen-containing off-gas discharge flow path 62 is mixed with the oxygen-containing gas supplied through the bypass channel 64 to dilute the fuel off-gas (including the fuel gas) in the oxygen-containing off-gas to a lower concentration, and the resulting oxygen-containing off-gas flows through the diluter 170.

In the exhaust passage 99 connected to the diluter 170, the fuel gas in the mixed fluid of the liquid water and the fuel off-gas discharged from the drain channel 162 is diluted by the oxygen-containing gas supplied from the bypass channel 64 and/or the oxygen-containing off-gas from the oxygen-containing off-gas discharge flow path 62, and is discharged to the outside (atmosphere) through the exhaust gas opening 168.

The controller 16 includes a memory and one or more processors (CPUs) that execute computer-executable instructions stored in the memory, and executes various types of processing through computation by the processors. The memory includes a volatile memory such as a RAM (random access memory) and a nonvolatile memory such as a ROM (read-only memory), a flash memory, and a hard disk. At least a part of the memory may be provided in the one or more processors.

The controller 16 controls the entire fuel cell system 10 including the compressor 28, the injector 32, and all valves such as the bypass valve 122 and so on.

A power switch (power SW) 300 for starting and stopping the fuel cell system 10 and the fuel cell vehicle 12 is connected to the controller 16.

When the power switch 300 is switched from the OFF state to the ON state, the controller 16 executes an activation control processing for starting operation of the fuel cell system 10.

### Operation

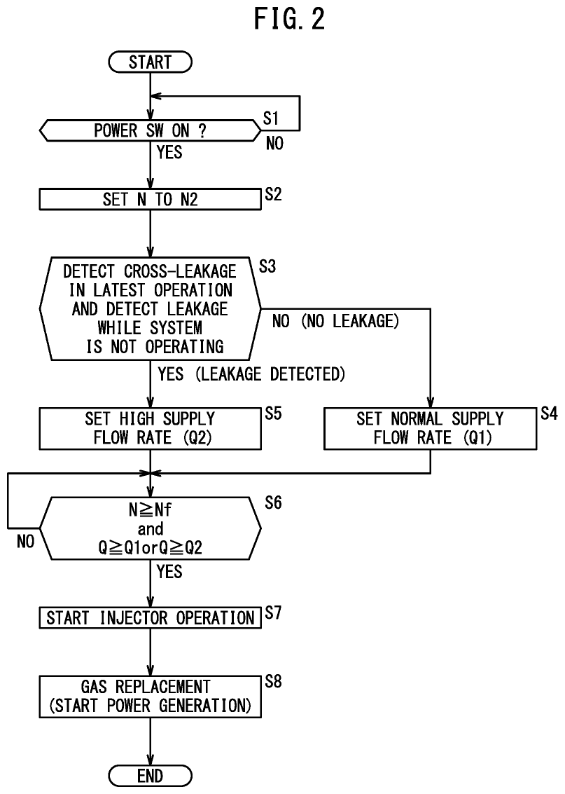

FIG. 2 is a flowchart illustrating an operational procedure of the activation control processing of the fuel cell system 10 by the controller 16.

In step S1, the controller 16 determines whether or not the power switch 300 has been switched from the OFF state to the ON state. When it is determined that the power switch 300 has been switched to the ON state (step S1: YES), the process transitions to step S2.

In step S2, the controller 16 sets the rotational speed N of the compressor 28 to the rotational speed N2 at which the oxygen-containing gas can be supplied from the compressor 28 at the second supply flow rate Q2 [m³/s], and simultaneously drives the compressor 28 through the drive unit 204 and monitors the rotational speed N of the compressor 28 (the rotational speed of the rotor).

Here, the second supply flow rate Q2 is a flow rate of the oxygen-containing gas relatively high enough to allow the fuel off-gas discharged from a drain valve 164 to be diluted by the diluter 170 and discharged to the atmosphere, as the exhaust gas with the hydrogen concentration equal to or lower than the predetermined concentration, through the exhaust passage 99 and the exhaust gas discharge port 168 even if the drain valve (fuel off-gas discharge valve) 164 is stuck in an open state due to freezing or the like.

The second supply flow rate Q2 is also a flow rate of the oxygen-containing gas relatively high enough to allow the fuel gas that is supplied at start-up, mixed with a nitrogen gas permeated (leaked) from the cathode flow field 58 to the anode flow field 59 through the membrane electrode assembly 52 while the fuel cell stack is not in operation, and discharged through the drain valve 164 to the diluter 170, so that the fuel gas is diluted to the predetermined concentration or less at the diluter 170 and then discharged to the atmosphere (referred to as “gas replacement at anode”).

When the controller 16 determines “step S1: YES”, the shut-off valve 114 and the bypass valve 122 are opened. On the other hand, the supply-side stop valve 118, the discharge-side stop valve 120, the bleed valve 70, and the drain valve 164 are kept in the closed state by the controller 16. The injector 32 is maintained in the OFF state by the controller 16.

In step S3, the controller 16 determines whether or not there was cross-leakage while the fuel cell stack was in the latest operation, and whether or not there was cross-leakage or leakage of the fuel gas remaining in the anode flow field 59 while the fuel cell stack was not in operation after the latest operation.

The cross-leakage (leakage of the fuel gas from the anode flow field 59 to the cathode flow field 58) during operation is recorded in the storage device (step S3: YES) in a case where the voltage sensor 110 detects a power generation cell 50 having a drop in the cell voltage Vcell during power generation.

While the fuel cell stack is not in operation, leakage is determined (step S3: YES) on the basis that the gas pressure Pa of the fuel off-gas detected by the pressure sensor 174 fluctuates by a predetermined value or greater when the power switch 300 is transitions from the ON state to the OFF state. In this case, it is considered that the drain valve 164 is stuck in the open state due to valve failure.

The cross-leakage occurred in the fuel cell stack not in operation is determined (step S3: YES) on the basis that the gas pressures Pk detected by the pressure sensor 180 fluctuates by a predetermined value or greater when the power switch 300 is transitions from the ON state to the OFF state.

When there is no leakage (step S3: NO), the controller 16 causes the process to transition to step S4, and when there is a leakage (step S3: YES), the controller 16 causes the process to transition to step S5.

In step S4, the controller 16 sets the flow rate of the oxygen-containing gas supplied from the compressor 28 to the oxygen-containing gas supply flow path 60A to a normal first supply flow rate Q1 which is a relatively small value, and causes the process to transition to step S6.

In step S5, the controller 16 sets the flow rate of the oxygen-containing gas supplied from the compressor 28 to the oxygen-containing gas supply flow path 60A to a relatively-high second supply flow rate Q2 which is a relatively large value, and causes the process to transition to step S6.

The first supply flow rate Q1 (rotational speed N1) and the second supply flow rate Q2 (rotational speed N2: N2>N1) are thresholds of the supply flow rate of the oxygen-containing gas used for dilution required to start the operation of the injector 32.

In step S6, the controller 16 confirms that the compressor 28 is operating normally when the monitored rotational speed N of the compressor 28 becomes equal to or higher than the floating rotational speed Nf at which the rotor floats (N≥Nf).

At the same time, in step S6, the controller 16 determines whether or not the supply flow rate Q (rotational speed N) has reached the first supply flow rate Q1 (rotational speed N1) or the second supply flow rate Q2 (rotational speed N2) set in step S4 or step S5.

When the determination in step S6 is established (N≥Nf and Q≥Q1, or N≥Nf and Q≥Q2), the controller 16 causes the process to transition to step S7.

In step S7, if no leakage is detected in step S3, the controller 16 starts the operation of the injector 32 when the rotational speed N of the compressor 28 reaches the rotational speed N1 corresponding to the first supply flow rate Q1. On the other hand, if leakage is detected in step S3, the controller 16 starts the operation of the injector 32 when the rotational speed N of the compressor 28 reaches the rotational speed N2 (N2>N1) corresponding to the second supply flow rate Q2 (Q2>Q1).

After starting the operation of the injector 32 in step S7, the controller 16 performs the gas replacement in step S8.

At step S8, the controller 16 opens the supply-side stop valve 118 and the discharge-side stop valve 120 to start power generation by the fuel cell stack 18, and causes the fuel gas that has permeated from the anode flow field 59 to the cathode flow field 58 through the membrane electrode assembly 52 while the fuel cell stack is not in operation to be diluted by the diluter 170 and discharged (referred to as gas replacement at cathode).

After the gas replacement at the cathode, the controller 16 opens the drain valve 164 to perform the gas replacement at the anode in which the nitrogen gas that has permeated from the cathode flow field 58 to the anode flow field 59 through the membrane electrode assembly 52 while the fuel cell stack is not in operation is replaced with the fuel gas.

### Explanation Using Timing Chart

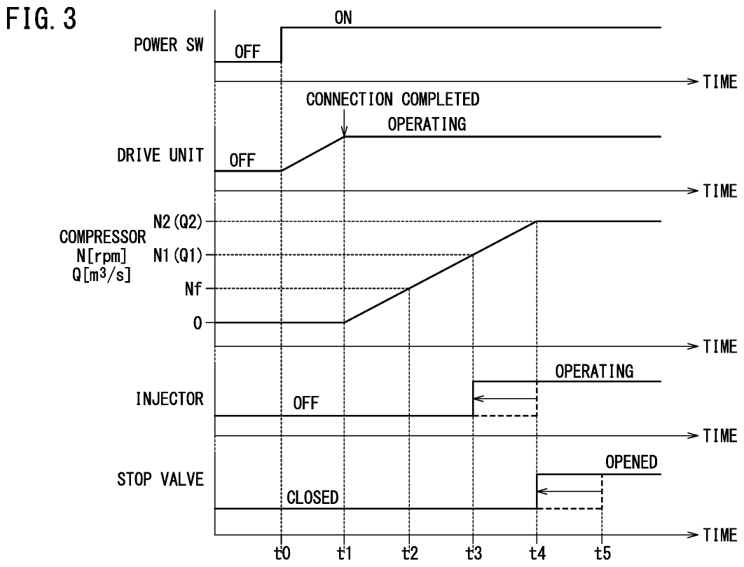

An example of the operation described with reference to the flowchart of FIG. 2 will be described with reference to the timing chart of FIG. 3.

At the time point to, upon detecting that the power switch 300 has transitioned from the OFF-state to the ON-state (step S1: YES), the controller 16 starts to connect a contactor (not illustrated) or the like of the drive unit 204.

When the connection of the drive unit 204 is completed at the time point t1, the controller 16 sets the rotational speed N of the compressor 28 to N2 (rotational speed at which the second supply flow rate Q2 is obtained) at the time point t1 (step S2) and drives the compressor 28.

The compressor 28 completes floating of the rotor at the time point t2 on the condition that the rotational speed N becomes Nf, and thereafter, the flow rate of the oxygen-containing gas supplied from the compressor 28 becomes stable.

In the case where no cross-leakage in the latest operation or no leakage while the fuel cell system is not in operation after the latest operation is detected (or leakage is detected at a level equal to or less than a negligible value), the controller 16 starts the operation of the injector 32, as indicated by a solid line, at a time point t3 when the rotational speed N of the compressor 28 becomes N1 (rotational speed at which the first supply flow rate Q1 is obtained).

Next, at a time point t4 when the rotational speed N of the compressor 28 becomes N2 (the rotational speed at which the second supply flow rate Q2 is obtained), the controller 16 opens the supply-side stop valve 118 and the discharge-side stop valve 120, as indicated by the solid line, to replace the gas in the cathode flow field 58 with the oxygen-containing gas (referred to as gas replacement at cathode).

After the replacement of a gas in the cathode flow field 58 with the oxygen-containing gas, the drain valve 164 is opened to perform the replacement of a gas in the anode flow field 59 with the fuel gas (referred to as gas replacement at anode).

Normally, in the gas replacement at the anode, nitrogen that has permeated from the cathode flow field 58 to the anode flow field 59 through the membrane electrode assembly 52 while the fuel cell system is not operating is also discharged to the atmosphere, and the anode flow field 59 is replaced with the fuel gas.

On the other hand, when cross-leakage in the latest operation or leakage while the fuel cell system is not in operation after the latest operation is detected, the controller 16 starts the operation of the injector 32 at a time point t4 when the rotational speed N of the compressor 28 becomes N2 (rotational speed at which the second supply flow rate Q2 is obtained), as indicated by a broken line.

In the case where cross-leakage in the latest operation or leakage while the fuel cell system is not in operation after the latest operation is detected, the controller 16 opens the supply-side stop valve 118 and discharge-side stop valve 120 at a time point t5 after a predetermined time from the time point t4, as indicated by a broken line, to replace a gas in the cathode flow field 58 with the oxygen-containing gas (gas replacement at cathode).

Also in this case, after the replacement with the oxygen-containing gas in the cathode flow field 58, the drain valve 164 is opened to replace a gas in the anode flow field 59 with the fuel gas (gas replacement at anode).

As described above, according to the above-described embodiment, in the case where leakage is not detected, the activation time can be shortened by setting the operation start time point of the injector 32 earlier than the time point t3, and even in the case where leakage is detected, the activation time can be shortened because the oxygen-containing gas flow rate is not limited as in the technique disclosed in JP 2004-172027 A.

Invention Obtained from Embodiments

Next, the invention understood from the above embodiment will be described below. It should be noted that, for ease of understanding, constituent elements are labelled with the reference numerals of those used in the embodiments, but the present invention is not limited to such constituent elements labelled with the reference numerals.

(1) The fuel cell system 10 according to the present invention includes the fuel cell stack 18 configured to generate electricity by electrochemical reactions between the fuel gas supplied to the anode 57 through the anode flow field 59 and the oxygen-containing gas supplied to the cathode 56 through the cathode flow field 58; the oxygen-containing gas supply device 22 configured to supply the oxygen-containing gas to the cathode flow field in the fuel cell stack through the oxygen-containing gas supply flow path 60, the oxygen-containing off-gas discharge flow path 62 through which the oxygen-containing off-gas having been subjected to the electrochemical reactions flows from the fuel cell stack 18, the bypass channel 64 connecting the oxygen-containing gas supply flow path and the oxygen-containing off-gas discharge flow path and configured to allow the oxygen-containing gas supplied from the oxygen-containing gas supply device to flow into the oxygen-containing off-gas discharge flow path while bypassing the cathode flow path in the fuel cell stack; and the controller 16 configured to control the fuel cell system, wherein the controller detects a fuel gas leakage while the fuel cell system is in operation and after the operation of the fuel cell system has been ended, and sets, based on the detection result, a flow rate of the oxygen-containing gas supplied at start-up in the case of no fuel gas leakage detected to be lower than a flow rate of the oxygen-containing gas supplied at start-up after the leakage of the fuel gas is detected.

According to this configuration, at the start-up of the fuel cell system, because the flow rate of the oxygen-containing gas to be supplied at the start-up is set on the basis of the detection result of the fuel gas leakage while the fuel cell system is in operation and is not in operation, it is possible to reduce the flow rate of the oxygen-containing gas supplied at the start-up. As a result, the activation time until power generation is started can be shortened.

In the case where fuel gas leakage has been detected by the time of the start-up, the flow rate of the oxygen-containing gas to be supplied is set to be larger than that set in the case of no leakage detected so as to shorten the time taken by dilution for lowering the concentration of the fuel gas to be discharged to the atmosphere, and consequently shorten the activation time. The present invention thus contributes to energy efficiency.

(2) Further, in the fuel cell system, the leakage of the fuel gas may be caused by cross-leakage inside the fuel cell stack or may be caused by a fuel off-gas discharge valve stuck in an open state due to valve failure, the fuel off-gas discharge valve being provided in a fuel off-gas discharge flow path 74 configured to allow the fuel off-gas having been subjected to the electrochemical reactions to be discharged from the fuel cell stack.

Thus, in the case of cross-leakage or in the case of the fuel off-gas discharge valve being stuck in the open state due to valve failure, the flow rate of the oxygen-containing gas supplied at the time of start-up is set to be high, so that the concentration of the fuel gas discharged to the atmosphere can be lowered by dilution.

(3) The fuel cell system may further include an injector 32 configured to inject the fuel gas into the fuel gas supply flow path 72 to supply the fuel gas to the anode flow field of the fuel cell stack, and at the start-up, the controller may allow the injector to inject the fuel gas when a supply flow rate of the oxygen-containing gas reaches the predetermined start-up supply flow rate of the oxygen-containing gas.

As a result, the activation time can be shortened while diluting the fuel gas discharged to the atmosphere at the time of start-up.

(4) The fuel cell system may further include: an injector configured to inject the fuel gas into the fuel gas supply flow path to supply the fuel gas to the anode flow field of the fuel cell stack; a supply-side stop valve 118 disposed in the oxygen-containing gas supply flow path and configured to adjust a flow rate of the oxygen-containing gas flowing through the oxygen-containing gas supply flow path; and a discharge-side stop valve 120 disposed in the oxygen-containing off-gas discharge flow path configured to discharge from the fuel cell stack the oxygen-containing off-gas having been subjected to the electrochemical reactions and adjust a flow rate of the oxygen-containing off-gas, wherein the controller allows the injector to inject the fuel gas when the supply flow rate of the oxygen-containing gas reaches the predetermined start-up supply flow rate of the oxygen-containing gas in a state where the supply-side stop valve through which the oxygen-containing gas flows and the discharge-side stop valve through which the oxygen-containing off-gas flows are closed at the start-up, and after the injector injects the fuel gas opens the supply-side stop valve and the discharge-side stop valve.

In this manner, because the injector is allowed to inject the fuel gas when the supply flow rate of the oxygen-containing gas reaches the supply flow rate of the oxygen-containing gas set for start-up in a state where the supply-side stop valve through which the oxygen-containing gas flows and the discharge-side stop valve through which the oxygen-containing off-gas flows are closed at the time of start-up, and after the injector injects the fuel gas, the supply-side stop valve and the discharge-side stop valve are opened to allow the fuel off-gas containing nitrogen cross-leaked from the cathode side to the anode side while the fuel cell system is not in operation to be diluted and discharged to the atmosphere, the activation time can be shortened.

(5) Further, in the fuel cell system, the controller may detect the leakage of the fuel gas while the fuel cell system is not in operation on the basis of a change in pressure in the anode flow field or a change in pressure in the cathode flow field of the fuel cell stack while the fuel cell system is not in operation. Accordingly, it is possible to easily detect the presence or absence of the leakage (including cross-leakage) while the fuel cell system is not in operation.

(6) Further, in the fuel cell system, the controller may detect the leakage of the fuel gas during operation of the fuel cell system based on a change in a power generation state. This makes it possible to easily detect the presence or absence of the cross-leakage during power generation.

Moreover, the present invention is not limited to the above-described disclosure, and various configurations can be adopted therein without departing from the essence and gist of the present invention.

1. A fuel cell system comprising:
a fuel cell stack configured to generate electricity by electrochemical reactions between a fuel gas supplied to an anode through an anode flow field and an oxygen-containing gas supplied to a cathode through a cathode flow field;
an oxygen-containing gas supply device configured to supply the oxygen-containing gas to the cathode flow field in the fuel cell stack through an oxygen-containing gas supply flow path,
an oxygen-containing off-gas discharge flow path through which the oxygen-containing off-gas having been subjected to the electrochemical reactions flows out from the fuel cell stack,
a bypass channel connecting the oxygen-containing gas supply flow path and the oxygen-containing off-gas discharge flow path and configured to allow the oxygen-containing gas supplied from the oxygen-containing gas supply device to flow into the oxygen-containing off-gas discharge flow path while bypassing the cathode flow path in the fuel cell stack; and
one or more processors that execute computer-executable instructions stored in a memory,
wherein the one or more processors execute the computer-executable instructions to cause the fuel cell system to:
detect a leakage of the fuel gas while the fuel cell system is in operation and after an operation of the fuel cell system has been ended; and
set, based on a detection result, a flow rate of the oxygen-containing gas supplied at start-up in a case of no leakage detected to be lower than a flow rate of the oxygen-containing gas supplied at start-up after the leakage of the fuel gas is detected.

2. The fuel cell system according to claim 1, further comprising:
a fuel off-gas discharge flow path through which a fuel off-gas having been subjected to the electrochemical reactions flows out from the fuel cell stack, wherein
the fuel off-gas discharge flow path includes a fuel off-gas discharge valve, and
the one or more processor cause the fuel cell system to detect the leakage caused by cross-leakage inside the fuel cell stack or the leakage caused by a fuel off-gas leaked through a fuel off-gas discharge valve stuck in an open state due to valve failure.

3. The fuel cell system according to claim 1, further comprising:
an injector configured to inject the fuel gas into a fuel gas supply flow path through which the fuel gas flows to the anode flow field of the fuel cell stack,
wherein at the start-up, the one or more processors cause the fuel cell system to allow the injector to inject the fuel gas when a supply flow rate of the oxygen-containing gas reaches a predetermined start-up supply flow rate of the oxygen-containing gas.

4. The fuel cell system according to claim 1, further comprising:
an injector configured to inject the fuel gas into a fuel gas supply flow path through which the fuel gas flows to the anode flow field of the fuel cell stack,
a supply-side stop valve disposed in the oxygen-containing gas supply flow path and configured to adjust a flow rate of the oxygen-containing gas flowing through the oxygen-containing gas supply flow path; and
a discharge-side stop valve disposed in the oxygen-containing off-gas discharge flow path configured to discharge from the fuel cell stack the oxygen-containing off-gas having been subjected to the electrochemical reactions and adjust a flow rate of the oxygen-containing off-gas,
wherein the one or more processors cause the fuel cell system to:
allow the injector to inject the fuel gas when the supply flow rate of the oxygen-containing gas reaches a predetermined start-up supply flow rate of the oxygen-containing gas in a state where the supply-side stop valve through which the oxygen-containing gas flows and the discharge-side stop valve through which the oxygen-containing off-gas flows are closed at the start-up; and
after the injector injects the fuel gas, open the supply-side stop valve and the discharge-side stop valve.

5. The fuel cell system according to claim 1, wherein the one or more processors cause the fuel cell system to:
detect the leakage of the fuel gas after the operation of the fuel cell system has been ended, on a basis of a change in pressure in the anode flow field or a change in pressure in the cathode flow field of the fuel cell stack after the operation of the fuel cell system has been ended.

6. The fuel cell system according to claim 1, wherein the one or more processors cause the fuel cell system to:
detect the leakage of the fuel gas during operation of the fuel cell system based on a change in a power generation state.
